(19) United States
(12) Patent Application Publication
(10) Pub. No.: US 2022/0050803 A1
(43) Pub. Date: Feb. 17, 2022

(54) Universal Serial Bus Type-C Adaptor Board

(71) Applicants: Inventec (Pudong) Technology Corporation, Shanghai (CN); Inventec Corporation, Taipei City (TW)

(72) Inventor: Xin-Ying Xie, Shanghai (CN)

(21) Appl. No.: 17/022,917

(22) Filed: Sep. 16, 2020

(30) Foreign Application Priority Data
Aug. 17, 2020 (CN) 202010823892.0

(51) Int. Cl. G06F 13/42; H01R 12/53; H01R 12/72

(52) U.S. Cl. CPC G06F 13/4282; G06F 2213/0042; H01R 12/722; H01R 12/53

(57) ABSTRACT

A USB type-C adapter board is disclosed. Through a circuit board electrically connected to a USB type-C connector and a JTAG connector, ground pins of the USB type-C connector and the JTAG connector can form a ground net, data output pins of the USB type-C connector and the JTAG connector can form a data output net, data input pins of the USB type-C connector and the JTAG connector can form a data input net, clock pins of the USB type-C connector and the JTAG connector can form a clock net, test mode selection pins of the USB type-C connector and the JTAG connector can form a test mode selection net.

### CROSS-REFERENCE TO RELATED APPLICATION

This application claims the benefit of Chinese Application Serial No. 202010823892.0, filed Aug. 17, 2020, which is hereby incorporated herein by reference in its entirety.

### BACKGROUND OF THE INVENTION

### 1. Field of the Invention

The present invention relates to an adapter board, and more particularly to a USB type-C adapter board.

### 2. Description of the Related Art

In recent years, the common universal serial bus (USB) type-C adapter board on the market is composed of a USB type-C female connector, a signal adapter circuit board and a plug terminal. The USB type-C female connector is electrically connected with a plurality of plug pins of the plug terminal through the signal adapter circuit board. The USB type-C female connector is connected to a cable to receive signal, and the plug terminal outputs the signal required by the user through DuPont lines, and it is more convenient than the way of directly outputting the signal required by the user through the USB type-C female connector with dense pins. However, in actual production and application, each time the USB type-C adapter board is to be connected to the cable, it is necessary to first check the signal definition of the plug pins of the plug terminal to determine which kind of signal outputted from each plug pin, and the production efficiency is greatly affected; furthermore, the connection between the DuPont lines and the plug pins may be loosen easily to cause poor contact and great inconvenience in application.

Therefore, how to solve the conventional problem of time consumption for checking whether the signal definition of each plug pin is correct each time the conventional USB type-C adapter board is to be connected to the cable, and the problem that the connection between the DuPont lines and the plug pins is easy to loose, is a key issue in the industry.

### SUMMARY OF THE INVENTION

An objective of the present invention is to provide a USB type-C adapter board, to solve the conventional technical problem.

In order to achieve the objective, the present invention discloses a USB type-C adapter board including a circuit board, a USB type-C connector and a JTAG connector. The USB type-C connector is electrically connected to a side of the circuit board and includes a first left ground pin, a first right ground pin, a first clock pin, a first data input pin, a first data output pin, a first test mode selection pin, a second left ground pin, a second right ground pin, a second clock pin, a second data input pin, a second data output pin and a second test mode selection pin. The JTAG connector is electrically connected to the other side of the circuit board and includes a plurality of third ground pins, a third clock pin, a third data input pin, a third data output pin and a third test mode selection pin. The first left ground pin, the first right ground pin, the second left ground pin, the second right ground pin and the plurality of third ground pins are connected with each other to form a ground net, through the circuit board. The first data input pin, the second data input pin and the third data input pin are connected with each other to form a data input net, through the circuit board. The first data output pin, the second data output pin and the third data output pin are connected with each other to form a data output net, through the circuit board. The first test mode selection pin, the second test mode selection pin and the third test mode selection pin are connected with each other to form a test mode selection net, through the circuit board. The first clock pin, the second clock pin and the third clock pin are connected with each other to form a clock net, through the circuit board.

According to an embodiment, the USB type-C connector supports the USB 3.0 transmission specification.

According to an embodiment, the JTAG connector is a connector with at least one of an interlocking structure and an anti-mistaking structure.

According to an embodiment, when the USB type-C adapter board is applied to boundary scan test environment, the USB type-C connector is connected to an interface adapter board which is an adapter board used in a fixture inspecting a DIMM slot, and the JTAG connector is connected to an TAP main board.

According to an embodiment, the USB type-C connector is a female connector.

According to the above-mentioned contents, the difference between the USB type-C adapter board of the present invention and conventional technology is that the USB type-C adapter board of the present invention includes the circuit board electrically connected to the USB type-C connector and the JTAG connector, the ground pins of the USB type-C connector and the JTAG connector can form the ground net, the data output pins of the USB type-C connector and the JTAG connector can form the data output net, the data input pins of the USB type-C connector and the JTAG connector can form the data input net, the clock pins of the USB type-C connector and the JTAG connector can form the clock net, the test mode selection pins of the USB type-C connector and the JTAG connector form the test mode selection net.

According to aforementioned technical solution, the USB type-C adapter board of the present invention can output the signal required for the USB type-C connector and prevent the time consumption, which is required in the conventional USB type-C adapter board, for checking whether the signal definition of each plug pin is correct, and the connection stability can be improved. Furthermore, when the JTAG connector is the connector with at least one of the interlocking structure and the anti-mistaking structure, the plugging direction of the connection between the JTAG connector and the cable can be ensured to be fixed, so as to prevent wrong plugging operation; furthermore, the JTAG connector with the interlocking structure also can ensure the firm connection with the cable.

### BRIEF DESCRIPTION OF THE DRAWINGS

The structure, operating principle and effects of the present invention will be described in detail by way of various embodiments which are illustrated in the accompanying drawings.

FIG. 1 is a schematic view of an appearance of an embodiment of a USB type-C adapter board of the present invention.

FIG. 2 is a schematic view of an embodiment of the USB type-C connector of FIG. 1.

FIG. 3 is a schematic view of an embodiment of the JTAG connector of FIG. 1.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

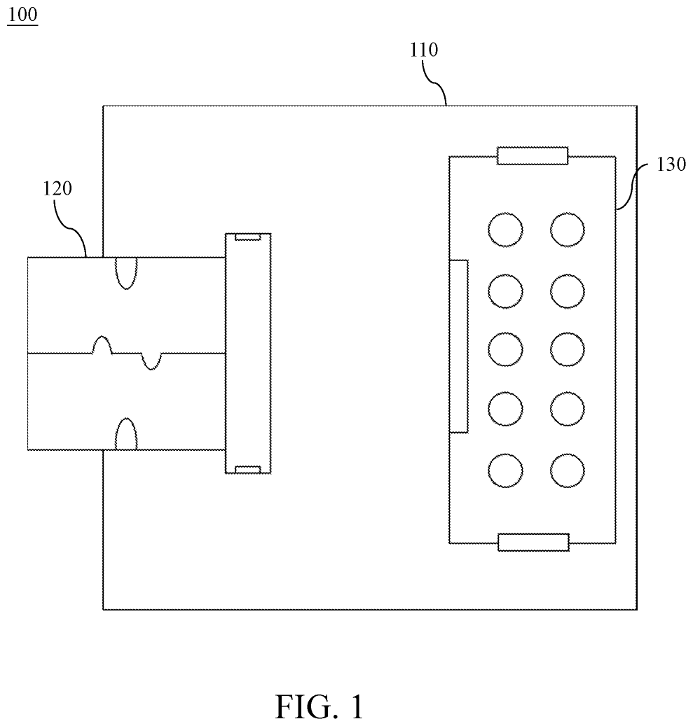

Please refer to FIG. 1, which is a schematic view of an appearance of an embodiment of a USB type-C adapter board of the present invention. In this embodiment, a USB type-C adapter board 100 includes a circuit board 110, a USB type-C connector 120 and a JTAG connector 130. The USB type-C connector 120 is electrically connected to a side of the circuit board 110, and the JTAG connector 130 can be electrically connected to other side of the circuit board 110. In an embodiment, the USB type-C connector 120 can support the USB 3.0 transmission specification, that is, the USB type-C connector 120 can support a commercial USB 3.0 type-C cable. In this embodiment, the USB type-C connector 120 can be, but not limited to, a female connector; in other words, in another embodiment, the USB type-C connector 120 can be a male connector.

Furthermore, in this embodiment, the connection direction of the USB type-C connector 120 to an external device is the horizontal direction of the drawing, and the connection direction of the JTAG connector 130 to an external device is the direction perpendicular to the drawing, that is, the connection direction of the JTAG connector 130 to an external device is the direction away from or close to the drawing; however, the present invention is not limited to above-mentioned example, and embodiment of the present invention can be adjusted upon practical demand.

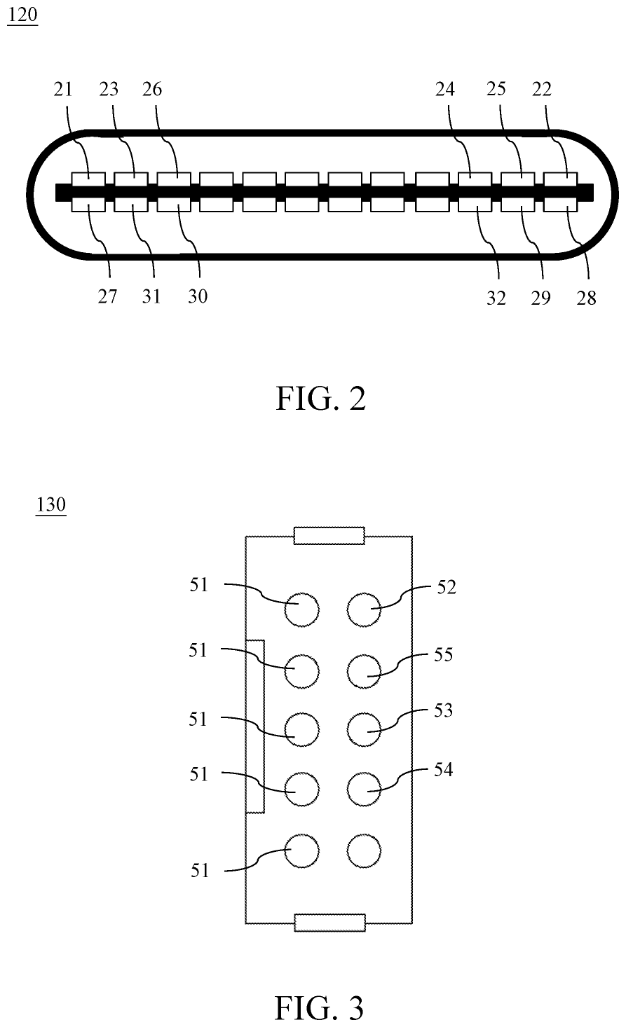

Please refer to FIG. 2, which is a schematic view of an embodiment of the USB type-C connector of FIG. 1. In this embodiment, the USB type-C connector 120 includes a first left ground pin 21, a first right ground pin 22, a first clock pin 23 (the clock pin is also called a test clock pin or a TCK pin), a first data input pin 24 (the data input pin is also called a test data in pin or a TDI pin), a first data output pin 25 (the data output pin is also called a test data out pin or a TDO pin), a first test mode selection pin 26 (the test mode selection pin is also called test mode select pin or a TMS pin), a second left ground pin 27, a second right ground pin 28, a second clock pin 29, a second data input pin 30, a second data output pin 31 and a second test mode selection pin 32. In an embodiment, the USB type-C connector 120 can be a standard USB type-C connector.

Please refer to FIG. 3, which is a schematic view of an embodiment of a JTAG connector of FIG. 1. In this embodiment, the JTAG connector 130 includes a plurality of third ground pins 51, a third clock pin 52, a third data input pin 53, a third data output pin 54, and a third test mode selection pin 55. The number of the third ground pin 51 can be five, but the present invention is not limited thereto; the JTAG connector 130 can be a connector having 2×5 pins.

In this embodiment, the first left ground pin 21, the first right ground pin 22, the second left ground pin 27 and the second right ground pin 28 of the USB type-C connector 120 can be connected to the third ground pins 51 of the JTAG connector 130 to form a ground net, through the circuit board 110. The first data input pin 24 and the second data input pin 30 of the USB type-C connector 120 can be connected to the third data input pin 53 of the JTAG connector 130 to form a data input net, through the circuit board 110. The first data output pin 25 and the second data output pin 31 of the USB type-C connector 120 can be connected to the third data output pin 54 of the JTAG connector 130 to form a data output net, through the circuit board 110. The first test mode selection pin 26 and the second test mode selection pin 32 of the USB type-C connector 120 can be connected to the third test mode selection pin 55 of the JTAG connector 130 to form a test mode selection net, through the circuit board 110. The first clock pin 23 and the second clock pin 29 of the USB type-C connector 120 can be connected to the third clock pin 52 of the JTAG connector 130 to form a clock net, through the circuit board 110.

Therefore, the USB type-C adapter board 100 can output the signal required for the USB type-C connector 120 and prevent the time consumption, which is required by the conventional USB type-C adapter board to check whether the signal definition of each plug pin is correct, and connection stability can further be improved.

Furthermore, the JTAG connector 130 can be a connector with at least one of an interlocking structure and an anti-mistaking structure, so that the plugging direction of connecting the JTAG connector 130 and the cable can be ensured to be fixed, thereby preventing wrong plugging operation; the JTAG connector 130 with the interlocking structure can also ensure stability of connection to the cable.

Furthermore, when the USB type-C adapter board 100 is applied to boundary scan test environment, the USB type-C connector 120 can be connected to an interface adapter board, which is not shown in figures; the interface adapter board is the adapter board used in a fixture inspecting the DIMM slot; the JTAG connector 130 can be connected to a test access port (TAP) main board, which is not shown in figures.

According to the above-mentioned contents, the difference between the USB type-C adapter board of the present invention and conventional technology is that the USB type-C adapter board of the present invention includes the circuit board electrically connected to the USB type-C connector and the JTAG connector, the ground pins of the USB type-C connector and the JTAG connector can form the ground net, the data output pins of the USB type-C connector and the JTAG connector can form the data output net, the data input pins of the USB type-C connector and the JTAG connector can form the data input net, the clock pins of the USB type-C connector and the JTAG connector can form the clock net, the test mode selection pins of the USB type-C connector and the JTAG connector can form the test mode selection net. Therefore, the USB type-C adapter board of the present invention can output the signal required for the USB type-C connector and prevent the time consumption, which is required by the conventional USB type-C adapter board to check whether the signal definition of each plug pin is correct, and connection stability can further be improved.

Furthermore, when the JTAG connector is a connector with at least one of the interlocking structure and the anti-mistaking structure, the plugging direction of the connection between the JTAG connector and the cable can be ensured to be fixed, to prevent wrong plugging operation; the JTAG connector with the interlocking structure can also ensure the firm connection with the cable.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A USB type-C adapter board, comprising:
a circuit board;
a USB type-C connector electrically connected to a side of the circuit board and comprising a first left ground pin, a first right ground pin, a first clock pin, a first data input pin, a first data output pin, a first test mode selection pin, a second left ground pin, a second right ground pin, a second clock pin, a second data input pin, a second data output pin and a second test mode selection pin; and
a JTAG connector electrically connected to the other side of the circuit board and comprising a plurality of third ground pins, a third clock pin, a third data input pin, a third data output pin and a third test mode selection pin;
wherein the first left ground pin, the first right ground pin, the second left ground pin, the second right ground pin and the plurality of third ground pins are connected with each other to form a ground net, through the circuit board;
wherein the first data input pin, the second data input pin and the third data input pin are connected with each other to form a data input net, through the circuit board;
wherein the first data output pin, the second data output pin and the third data output pin are connected with each other to form a data output net, through the circuit board;
wherein the first test mode selection pin, the second test mode selection pin and the third test mode selection pin are connected with each other to form a test mode selection net, through the circuit board;
wherein the first clock pin, the second clock pin and the third clock pin are connected with each other to form a clock net, through the circuit board.

2. The USB type-C adapter board according to claim 1, wherein the USB type-C connector supports the USB 3.0 transmission specification.

3. The USB type-C adapter board according to claim 1, wherein the JTAG connector is a connector with at least one of an interlocking structure and an anti-mistaking structure.

4. The USB type-C adapter board according to claim 1, wherein when the USB type-C adapter board is applied to boundary scan test environment, the USB type-C connector is connected to an interface adapter board which is an adapter board used in a fixture inspecting a DIMM slot, and the JTAG connector is connected to an TAP main board.

5. The USB type-C adapter board according to claim 1, wherein the USB type-C connector is a female connector.
